(19) United States
(12) Patent Application Publication
(10) Pub. No.: US 2006/0059548 A1
(43) Pub. Date: Mar. 16, 2006

(54) System and method for policy enforcement and token state monitoring

(76) Inventors: Eric Arnold Hildre, Lorton, VA (US); Theodore Delano Putnam, Williamsburg, VA (US)

Correspondence Address: George A. Willinghan, III Attorney-At-Law;August Law Group LLC, P.O. Box 19080, Baltimore, MD, 21284, US

(21) Appl. No.: 11/170,248

(22) Filed: Jun. 29, 2005

Related U.S. Application Data
(63) Continuation-in-part of application No. 10/931,876, filed on Sep. 1, 2004.

(51) Int. Cl. H04L 9/32

(52) U.S. Cl. 726/9

(57) ABSTRACT

Systems and methods for monitoring the state of a token and communication exchanges between the token containing an embedded integrated circuit chip and a system are provided. Communications between the token and the system are established and the exchanged of commands and responses between the token and the system are monitored and evaluated for compliance with an identified policy. The identified policy contains lists of impermissible commands, responses and content, and delivery of the commands and responses is contingent upon compliance with the identified policy. The token is in communication with a token reader which communicates with the system using token reader driver software. Either the token reader driver software or the token itself is adapted to provide for the desired monitoring, evaluation and policy enforcement. Systems and methods are also provided that enforce policies at access points within a physical access system. The physical access system can be used in combination with tokens.

### CROSS-REFERENCE TO RELATED APPLICATIONS

The present invention is a continuation-in-part of co-pending U.S. application Ser. No. 10/931,876 filed Sep. 1, 2004. The entire disclosure of that application is incorporated herein by reference.

### FIELD OF THE INVENTION

The present invention is directed to systems and methods for providing policy enforcement for electronic communications employing Public Key Infrastructure technology and in physical access systems and to systems and methods for monitoring the state of a token.

### BACKGROUND OF THE INVENTION

Organizations, for example large commercial enterprises and governments, have a fundamental need to protect and secure sensitive and proprietary information and to provide secure access to installations, computer systems and computer networks. Typically, organizations employ a combination of policies, procedures and technologies to secure these assets. However, experience and history have proven that unless policies and procedures are systematically applied, they are particularly difficult to enforce.

Such enforcement difficulties exist in electronic messaging systems such as E-mail. Electronic messages present two significant risks. First, electronic messages are often transmitted over public, unsecured or un-trusted networks, creating a significant risk to message authenticity, i.e. determining if the message is real, message integrity, i.e. determining if someone intercepted and modified the message, and message confidentiality, i.e. determining if an unauthorized party read the contents of the message. Second, recipients of electronic messages can fail to apply proper security procedures when reading or opening messages, for example opening mail from unknown senders or executing attachments. Consequently, organizations are employing various techniques to improve the security of the information contained in electronic messages. One of these techniques is Public Key Encryption.

Public Key Encryption, also referred to as asymmetric encryption, provides for the secure transfer of messages across networks and in particular unsecured networks. In general, Public Key Encryption uses matched pairs of public keys and private keys. The public key is an encryption key, and the private key is the associated decryption key. Each user broadcasts its public key across a network and maintains the associated private key in secret. Each key is constructed such that one key cannot be derived from the other.

In order to send a secure message to a recipient, a sender obtains the public key for the recipient, which has been broadcast across the network by the recipient. Using the public key, the sender encodes the message and sends the encoded message to the recipient. The recipient receives the encoded message, and using its associated private key, which only the recipient knows, the recipient decodes the message.

Public Key Encryption is also useful in providing signed electronic messages that are dependent on both the signature associated with the message and the content of the message. A user receiving a signed message can be assured that the message has not been tampered with and can also be assured that the message is authentic, i.e. that the message originated from the indicated sender. Signed messages cannot be modified by recipients, and the attached signatures can not be used by recipients as signatures for other messages. In addition, signatures prevent senders from disclaiming sending the message at a later time. Therefore, Public Key Encryption is used to provide for tamper detection, authentication and non-repudiation of messages exchanged between two users across the network.

In order to send a secure, signed message, the sender uses its own private key to generate a signed message and then uses the recipient's public key to encode the signed message. The sender then sends the encoded, signed message to the recipient. The recipient, upon receipt of the encoded, signed message, initially uses its own private key to decode the message. Then, the recipient uses the sender's public key to decode the signed message. Authentication and non-repudiation are provided since only the sender could have signed the message using its private key and the recipient had to use the sender's public key to decode the signed message. The recipient cannot modify the signed document, because once the signed document from the sender is decoded, the recipient would need to know the sender's private key to sign the document again after modification.

Security and integrity throughout a system using Public Key Encryption depends on the cryptographic security and integrity of the public and private keys. Public Key Infrastructure (PKI) refers to a system by which public keys can be managed on a secure basis for use by widely distributed users or systems. PKI supports digital signatures and other public key enabled security services.

PKI enables users of a basically non-secure public network, for example the Internet, to securely and privately exchange data or electronic messages through the use of the public and private key pairs by providing for digital certificates that can identify a user or group of users and for directory services that can store and, when necessary, revoke the certificates. A digital certificate is an electronic identification card that establishes each user's credentials when exchanging messages or other data across the network. Generally contained within each digital certificate is the associated user's name, a serial number, expiration dates, a copy of the user's public key and the digital signature of the certificate-issuing authority so that a recipient can verify that the certificate is real. Digital certificates are issued and verified by a certification authority (CA) and can be kept in registries so that authenticating users can look up other users' public keys.

The CA is an authority in a network that issues and manages security credentials and public keys for message encryption and other purposes. As part of the PKI, the CA checks with a registration authority (RA) to verify information provided by the requestor of a digital certificate. If the RA verifies the requestor's information, the CA can then issue a certificate. A certificate management system is used to guide the verification of information and issuance of certificates. A digital certificate contains the digital signature of the CA so that anyone can verify that the certificate is authentic.

In PKI, the public and private keys are created simultaneously by the CA using the same algorithm. The private key is given only to the requesting user, and the public key is made publicly available as part of a digital certificate contained in a public directory that all users can access. The private key is never shared with anyone or sent across the network. There is currently no single, world-wide CA. But a group of local or regional CA's exist that use cross-certification to permit one CA to vouch for the authenticity of another CA.

Therefore, a PKI is a collection of CA's arranged in a hierarchic structure. A root or top-level CA certifies lower level CA's which then certify even lower level CA's or end users. Interoperability and mutual recognition among these CA's are important aspects of the operation of the PKI. Also, rules need to be enforced among the CA's and users to ensure the integrity of the PKI system and to avoid abuses or errors in certification.

PKI is a dynamic system where the validity of each certificate changes over time due to factors including a change in the status of users and a change in the certificate validation policies. These changes need to be managed by all of the CA's and to be distributed to increasing numbers of concurrent users. Current PKI systems do not provide adequate scalability and reliability for certificate validation. These systems do not readily scale to an increasing number of users or certificates and do not accommodate a large number of applications. In addition, current systems do not provide sufficient flexibility to permit efficient utilization of system resources. For example, not all electronic communications are of a sensitive nature; however, current systems require that all electronic messages be verified. Therefore, if system capacity is insufficient to provide for certificate validation for the volume of messages, then either the transmission will fail or none of the electronic messages will be verified. In addition, if a timely certificate revocation list (CRL), which is the list that is used for certificate verification, is unavailable, the electronic communication simply fails. Current CRL's are large in size and are continuing to grow, presenting a significant demand on system bandwidth.

Such enforcement difficulties exist in physical access systems that are used to control access to secure areas and buildings for example military installations, government facilities, research and medical facilities. Most physical access systems are stand-alone systems that provide access based upon a limited number of predetermined and static factors. In order to update these factors, the physical access system itself has to be updated locally. However, physical access systems also represent dynamic systems where the level of security and a given person's level of clearance can change over time due to a variety of factors. In addition, current physical access systems do utilize networks or centralized systems that provide regular updates regarding access parameters.

Some security systems utilize token technology to provide authenticity, integrity, confidentiality, tamper detection and non-repudiation for exchanged messages and data and for access to computer networks, computer systems and secure facilities. In general, token technology provides for portable authentication and is becoming increasingly prominent as the need to authenticate and identify individuals and not merely computers grows. Token technologies can be used alone or in combination with PKI systems. However, current applications of token technology in combination with PKI need a crypto-coprocessor to provide satisfactory response times. In addition, standards that facilitate and promote interoperability are lacking.

One type of token technology is smart card technology. Smart card technology has been in existence for about 30 years, and smart cards are used regularly for a wide variety of applications including stored value (pay phones, vending machines, parking, etc.) as well as health data storage and electronic purse applications.

A smart card is about the size of a credit card and includes a variety of features that are used for purposes of identification including a linear barcode, a magnetic strip, a two-dimensional barcode, a color digital photograph, printed text and an embedded integrated circuit chip. The smart card uses these features to store data that are used for identification, demographics, physical security, authenticity, integrity, confidentiality, tamper detection, non-repudiation and card management. The embedded integrated circuit chip provides the smart card with the ability to write, to read and to execute functions and operations on several thousand bytes of information. The smart card is also used in combination with biometric information. For example, a thumb print, index finger print or retinal scan is digitally encoded on the smart card. The smart card can also be used in combination with PKI. For example, the smart card can serve as a hardware token containing several keys for use in public-key infrastructure systems.

Data stored on the smart card are protected by a personal identification number (PIN) that is typically six to eight digits in length. This PIN is typically created by the user and must be entered in order to access the input, output and executable functions of the integrated circuit chip. Smart cards are used to log users onto computers and computer networks. Digital certificates are stored on smart cards, which enables users to digitally sign documents and to complete transactions that require signatures such as purchase orders. Besides security functions, smart cards are used in applications to increase productivity while reducing operational costs. For example, smart cards are used as access cards at buildings and installations worldwide and to facilitate administrative function such as travel expense reimbursements.

The ability to read, write and execute from a common access card provides a potential security problem for the buildings or facilities and computer networks in connection with which the common access card is used. The common access card, and in particular the storable memory component of the card, can be used to introduce viruses into the computer networks and computer systems and can also be used to download classified or confidential information from any computer network.

Therefore, a system is needed that can provide for continuous and reliable verification of digital certificates and other defined policies and rules given changing conditions. Suitable systems would be able to handle large numbers of users simultaneously and be scalable to growing numbers of users. In addition, the system would provide for easy user-defined modification of certificate validation policies and would be suitable for use in high security systems such as e-commerce and tactical applications. The system will accommodate the current certificate validation demands within available bandwidth and will be transparent to the end-users.

### SUMMARY OF THE INVENTION

The present invention is directed to a policy verification service, for example an extensible policy verification service (XPVS), that facilitates the application of user-defined policies to structured electronic messages, for example E-mails, and the implementation of corresponding business rules based on user, system, device or electronic message attributes. The present invention provides an easily scalable, extensible and reliable solution to enforcing policies in electronic communications.

The service includes a method for policy enforcement in electronic messages that includes identifying one or more policies to be applied to an electronic message sent from a first end entity or user to a second end entity or user and identifying at least one business rule to be applied to the electronic message. The electronic message is evaluated for applicability with the identified policy or policies, and the electronic message is routed in accordance with the policy evaluation and the identified business rules.

In order to identify each policy, one or more decision points are identified. The decision points can be chosen from a list of pre-defined decision points or can be inputted by the user. Each decision point defines a process used to evaluate a quality of the electronic message to be evaluated. The decision points include verifying that the electronic message is signed, verifying that the electronic message is signed using a signature certificate issued by a trusted certificate authority, verifying that the first end entity owns the signature certificate, verifying that the signature certificate has not expired, verifying the signature certificate by verifying a certificate authority signature, verifying that a certificate revocation list to be used to verify the signature certificate is available and updated, verifying that the electronic message has not been modified after being sent by the first end entity, verifying a domain associated with the first end entity, verifying a domain associated with the second end entity, verifying that the electronic message is in the proper format and combinations thereof.

Associated with each identified decision point is one or more actions to be taken based upon the evaluation of the electronic message. Examples of these decision point actions include sending the electronic message to the second end entity, routing the electronic message to a third party, rejecting the electronic message, modifying the electronic message, notifying the first end entity regarding results of the policy evaluation, notifying second end entities regarding the results of the policy evaluation, notifying the third party regarding the results of the policy evaluation, returning the electronic message to the first end entity and combinations thereof. Therefore, each identified policy is a collection of one or more pairs of decision points and decision point actions.

Policies and business rules can be applied uniformly across all electronic messages or can be tailored to electronic message-based factors that can vary from message to message. These factors can be taken into account during the creation of decision points, the selection of decision points, the creation of decision point actions, the association of decision point actions with the decision points, the creation of each policy and the selection of one policy from among a plurality of identified policies. Message-based factors can also be taken into account when identifying or applying business rules. Assistance in creating policies based upon message content can be provided by creating one or more decision point selection templates to assist in selecting decision points based upon electronic message content. The desired decision points are then selected based upon one of the templates.

In order to enforce the identified policies and business rules in electronic messages, each electronic message is evaluated against the associated policies. The messages are then handled or routed in accordance with these evaluations and any identified business rules. Examples of routing procedures include sending the electronic message to the second end entity, routing the electronic message to a third party, rejecting the electronic message, modifying the electronic message, notifying the first end entity regarding results of the policy evaluation, notifying second end entities regarding the results of the policy evaluation, notifying the third party regarding the results of the policy evaluation, returning the electronic message to the first end entity and combinations thereof.

The service also includes a system for certificate validation of electronic messages exchanged among a plurality of users in communication with each other across one or more networks. The system includes at least one extensible policy verification server capable of evaluating the PKI certificates within the electronic messages and of evaluating those messages for compliance with pre-defined policies and business rules. The extensible policy verification server also includes a policy engine capable of enforcing the policies and business rules, a policy builder capable of building the policy engine and a policy engine definition file to store a complete definition of the policy engine. The policy engine contains a plurality of simple policy nodes that each defines a specific policy test and resulting action and a plurality of macro policy nodes that define combinations of the simple policy nodes.

Also included in the extensible policy verification server is a messaging queue to intercept incoming and outgoing electronic messages for evaluation by the policy engine and a scheduler to schedule the evaluation of electronic messages in the messaging queue by the policy engine. In order to handle PKI certificate validation, the extensible policy verification server is in communication with one or more Certificate Revocation List Distribution Points from which it can acquire certificate revocation lists (CRL). The extensible policy verification server is capable of using multiple certificate validation techniques to validate certificates.

The present invention is also directed to a method for monitoring the state of an token and communication exchanges between the token containing an embedded integrated circuit chip and a system. The method includes establishing communication between the token and the system, monitoring the exchange of commands from the system to the token and of responses from the token to the system, evaluating the exchange of commands and responses for compliance with an identified policy and controlling the exchange of commands and responses in accordance with the policy compliance evaluation.

Communication between the token and the system is established by bringing the token into communication with either a contact or contact-less token reader that is in communication with the system, for example through software protocol stack. The token reader utilizes a token reader driver to communicate through the stack to the system, and at least one of the token reader driver and the token are modified to provide the desired policy enforcement for communication exchanges between the token and the system. Exchanges between the token and the system are monitored, for example by monitoring the application data protocol units exchanged between the token and the system. In general the authentication protocol data units form commands submitted from the system to the token and responses submitted from the token to the system.

The monitored commands and responses are evaluated against pre-defined polices for a determination of compliance with these policies. Non-complaint exchanges are blocked, and compliant exchanges are delivered. The policies include lists of impermissible commands and responses and lists of impermissible content in the commands and responses. In additional, the policies include lists of commands and responses that will place the token into an illegal state. This list of commands and responses is determined by maintaining a historical record of exchanged commands and responses and the current operational state of the token. The type and content of the exchanged commands and responses is determined by evaluating the various data fields associated with each command and response. Monitoring and evaluation of the commands and responses is repeated iteratively so that all exchanged commands and responses are evaluated.

Exemplary embodiments of the present invention are also directed to an token firewall containing an token having an embedded integrated circuit chip, a token reader capable of communicating with the embedded integrated circuit chip and a token reader driver that provides communication between the token reader and a system with which the token interacts. The token reader driver includes a communication monitor capable of monitoring an exchange of commands from the system to the token and of responses from the token to the system, a policy engine capable of analyzing the exchange of commands and responses for compliance with a pre-defined policy and a communication controller capable of prohibiting delivery of commands and responses that are not in compliance with the pre-defined policy.

Any type of suitable token can be used including smart cards or common access cards. When the token is a common access card, the token reader is a card access device. Also included within the token reader driver is a policy builder capable of building and updating the policy engine and a token state monitor capable of monitoring a current operational state of the token and of logging a historical record of previous operational states of the token.

The embedded integrated circuit chip within the token includes persistent non-modifiable memory, non-persistent modifiable memory, persistent modifiable memory or combinations thereof. At least one of the persistent non-modifiable memory, the non-persistent modifiable memory and the persistent modifiable memory includes a token level policy engine capable of enforcing a token level policy.

Exemplary embodiments in accordance with the present invention are directed to policy verification at various access points within a physical access systems. In accordance with this method, a request for access is received from a requesting entity at a point of access within the physical access system and communicated to a field panel. The field panel obtains profile information for the requesting entity and creates a profile ticket at the field panel containing this profile information. In order to gather the desired profile information, the field panel uses interface devices located at the point of access, e.g. key pads, touch screens and card readers.

The resulting profile ticket is forwarded to a policy engine server that uses the profile ticket to generate at least one request specific policy. In addition, the policy engine reviews the profile information contained in the profile ticket and gathers any additional information that may be needed to select an appropriate policy. Examples of this additional information include the current threat condition or threat-con, time of day, day of week, date, holiday status, existence of classified meetings and combinations thereof. The profile information and the additional gathered information is then matched to a pre-defined policy, for example matching the profile information and gathered information to at least one policy from a list of pre-defined policies.

The policy engine now has the profile information and the policy and can evaluate the policy using the profile information. However, the information in the profile can be insufficient for a proper or thorough evaluation. Therefore, the policy engine determines if additional data are needed to evaluate the request for access against the identified policy. If additional data are needed, the additional data needed to perform the evaluation are identified, and a list of tasks sufficient to obtain the additional data is created. The list of tasks is added to the profile ticket to create a task request ticket which is forwarded to at least one field panel within the physical access system. The field panel uses the list of tasks to obtain the additional data. The additional data are added to the task request ticket to create an updated profile ticket which is forwarded or returned to the policy engine server.

The policy then evaluates the request for access against the request specific policy to generate an access decision, i.e. whether or not to grant access to the requesting entity or to take another action. The initial profile information and any additional data that were obtained are used in the evaluation. The generation of the access decision includes identifying one or more actions to be taken at the point of access. These actions include granting access, denying access, providing feedback to the requesting entity, notifying a third party, securing the point of access or combinations thereof. The access decision including any actions is added to the profile ticket to create an access decision ticket which is forwarded to one or more field panels within the physical access system. Access is then granted to the requesting entity by the field at the point of access in accordance with the access decision.

### BRIEF DESCRIPTION OF THE DRAWINGS

FIG. 1 is a schematic representation of a networked application of a system in accordance with the present invention;

FIG. 2 is a schematic representation of an embodiment of a system in accordance with the present invention;

FIG. 3 is a flow chart illustrating an embodiment of a method for policy enforcement in accordance with the present invention;

FIG. 4 is a flow chart illustrating an embodiment for the identification of a policy;

FIG. 5 is a flow chart illustrating another embodiment of a method for policy enforcement in accordance with the present invention;

FIG. 6 is a flow chart illustrating an embodiment of sending a signed, encoded message for validation in accordance with the present invention;

FIG. 7 is a flow chart illustrating an embodiment of policy enforcement and routing in accordance with the present invention;

FIG. 8 is a block diagram illustrating an embodiment of a token policy enforcement system in accordance with the present invention;

FIG. 9 is a flow chart illustrating an embodiment of a method for enforcing policies between a token and a system;

FIG. 10 is a flow chart illustrating an embodiment of a method for monitoring, evaluating and controlling exchanges between an token and system;

FIG. 11 is a schematic representation of an embodiment of a physical access system for use with the policy enforcement system in accordance with the present invention; and

FIG. 12 is a flow chart illustrating an embodiment of a method for policy enforcement in a physical access system in accordance with the present invention.

### DETAILED DESCRIPTION

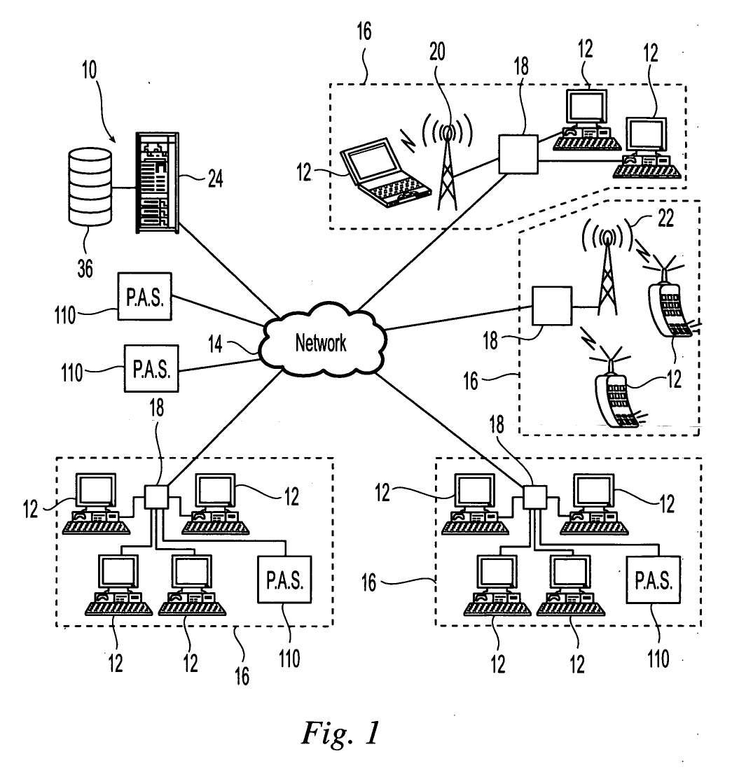

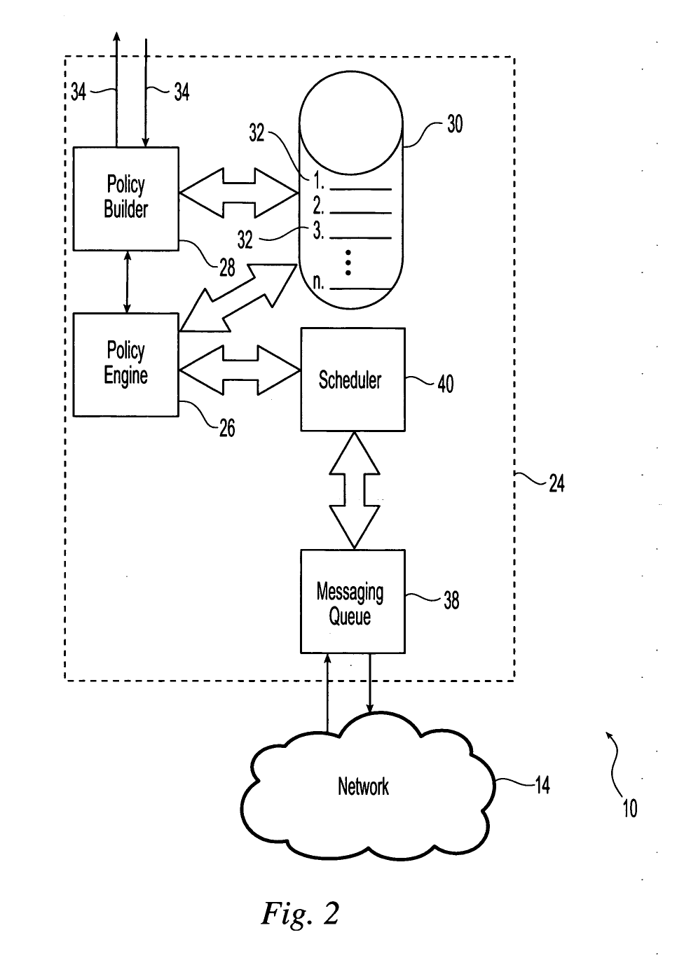

Referring initially to FIGS. 1 and 2, the present invention is directed to a system 10 for enforcing policies, for example security or encryption polices, and business rules in electronic messages sent across secure and un-secure networks. For example, the system 10 is used to provide signature certificate validation of electronic messages. In one embodiment as illustrated a plurality of end entities or users 12 are in communication with each other across one or more networks 14. As used herein, an end entity refers to a person or device that is capable of sending and receiving electronic messages across the network 14.

The electronic messages can be text-based messages and can include audio and video components. Suitable formats for the electronic messages include E-mail, with and without attachments, instant messaging and other text-based messaging systems. The electronic messages can be produced using any commercially available electronic messaging software and with any operating system or hardware platform. In addition, the system and method in accordance with the present invention can be integrated into customizable or proprietary electronic messaging systems and can be used with tactical applications. Suitable networks 14 over which the end entities 12 communicate include wide area networks such as the Internet or World Wide Web, local area networks (LAN), secure area networks, virtual private networks (VPN), public switched telephone networks (PSTN) and combinations thereof.

In one embodiment, all of the end entities 12 can be located in the same network domain. Alternatively, the end entities 12 are grouped together in different domains 16. In addition, each end entity 12 can be in communication with a local server 18, for example an internet service provider (ISP). In one embodiment, each local server 18 is associated with a particular domain 16 and facilitates the sending and receiving of electronic messages for end entities 12 within that domain 16. The end entities 12 can be in communication with the local server 18 and network 14 through standard wire-line connections such as telephone lines, digital subscriber lines, co-axial cable lines, T-1 lines and fiber-optic lines. In addition, the end entities 12 can be in communication with the local servers 18 and network 14 through local area wireless connections 20 utilizing Bluetooth and 802.11-type technologies and through wide area wireless connections 22 utilizing cellular transmitting technologies, for example cellular phones and Blackberry® systems and satellite communication and transmission systems. The system and method in accordance with the present invention can identify the type of communication connection associated with each end entity and can differentiate among these various communications when evaluating electronic messages against policies and business rules.

In one embodiment, as illustrated in FIG. 1, one or more physical access systems 110 are provided in communication with the system 10. The physical access systems 110 can be in communication with the system through the networks 14 and can also be disposed in one or more of the different domains 16 an in communication with the local servers 18 in those domains. Suitable physical access systems include any type of system that provides for limiting or controlling physical access to any type of physical area including buildings, military installations, research laboratories, office buildings, offices, rooms, banks, government buildings, military installations, automobiles, hospitals, public works facilities, power plants, restricted areas, roadways or interstates and combinations thereof.

The system 10 includes at least one certificate verification or access parameter verification server 24. Any certificate verification access parameter verification server 24 capable of intercepting the electronic messages being exchanged among the end entities 12 is suitable to be used with the system 10 and of providing updated access parameter data to one or more physical access systems can be used. Alternatively, separate servers are provided for certificate verification and for access parameter verification.

In one embodiment, the certificate verification server 24 is capable of employing a variety of techniques to validate a certificate associated with an electronic message and of using one or more of these techniques at the same time for a certificate validation operation. Suitable certificate validation techniques include, but are not limited to, Certificate Revocation Lists as defined by RFC 3280, Online Certificate Status Protocol (OCSP) as defined by RFC 2560 and Simple Certificate Status Protocol (SCVP). Preferably, the certificate verification server includes an extensible policy verification server 24. In one embodiment, the extensible policy verification server 24 is capable of utilizing certificate revocation lists for an extended period of time beyond the validity period or expiration of a given certificate. This extended period of time can be user-defined.

Once intercepted, the extensible policy verification server evaluates messages for compliance with pre-defined policies and business rules. In one embodiment, one or more of the local servers 18 also act as extensible policy verification servers. Preferably, the extensible policy verification servers 24 are one or more independent servers, that is are independent of and separate from the local servers 18. These independent servers are in communication with each end entity and with the local servers 18 across the network 14 so that the independent servers can receive and forward electronic messages among the various end entities 12. Preferably, the extensible policy verification server 24 is a single, centralized server.

In one embodiment as illustrated in FIG. 2, the extensible policy verification server 24 includes a policy engine 26 capable of enforcing the policies and business rules. The policy engine 26 contains the logic or logical arguments that constitute the policies and business rules that are used to evaluate the electronic messages. These logical arguments include simple policy nodes. Each policy node contains the logical structure for a specific decision point and the resulting decision point action. The logical arguments also include macro policy nodes. Macro policy nodes provide the logic for specifying more complex policies by combining two or more simple policy nodes. Therefore, each policy against which the electronic messages are evaluated typically contains two or more decision points paired with the resulting decision point actions. In one embodiment, the extensible policy verification server comprises a plurality of policy engines. Each policy engine is associated with one or more certification authorities containing one or more revocation lists.

In order to construct the policy engine 26, the extensible policy verification server includes a policy builder 28. The policy builder is in communication with a policy engine definition file 30 that it uses to store the policy definitions for the policy engine 26 including simple policy nodes 32, macro policy nodes and static attributes. The policy engine 26 is also in communication with the policy engine definition file 30. The policy builder 28 includes inputs and outputs 34 for accepting user-defined policies for use in building the policy engine 26. Preferably, the policies and business rules used in accordance with the present invention are constructed, expressed and stored in a human readable format, for example extensible markup language (XML), making the system and methods of the present invention easy to use and to customize. This storage can be accomplished using a graphical user interface (GUI) or by hand when creating the XML policy engine definition file.

In addition to the policy engine definition file 30, the extensible policy verification server 24 can include or can be in communication with one or more computer readable storage mediums 36, i.e. databases, that contain computer readable code for use by the policy engine 26 in evaluating the electronic messages and also for providing other operating functions of the extensible policy verification server 24. In one embodiment, the computer readable code includes thread-safe routines. The storage mediums 36 can include component libraries containing modularized components, for example dynamic link libraries (DLL) that support the policy enforcement mechanisms.

In order to facilitate the evaluation of electronic messages and in particular to provide for the verification of signature certificates, the extensible policy verification servers 24 have access to one or more certificate revocation lists (CRL's). A CRL can be obtained, for example, from a certificate authority (CA) with which the extensible policy verification server 24 is in communication across the network 14. In one embodiment, the extensible policy verification server 24 regularly obtains updated CRL's and stores the updated CRL's in the storage medium 36 for access by the server or policy engine 26. In one embodiment, the policy engine definition file 30 is contained on the storage medium 36.

The extensible policy verification server 24 also includes a messaging queue 38 to intercept incoming and outgoing electronic messages for evaluation by the policy engine and a scheduler 40 to schedule the evaluation of electronic messages in the messaging queue 38 by the policy engine 26.

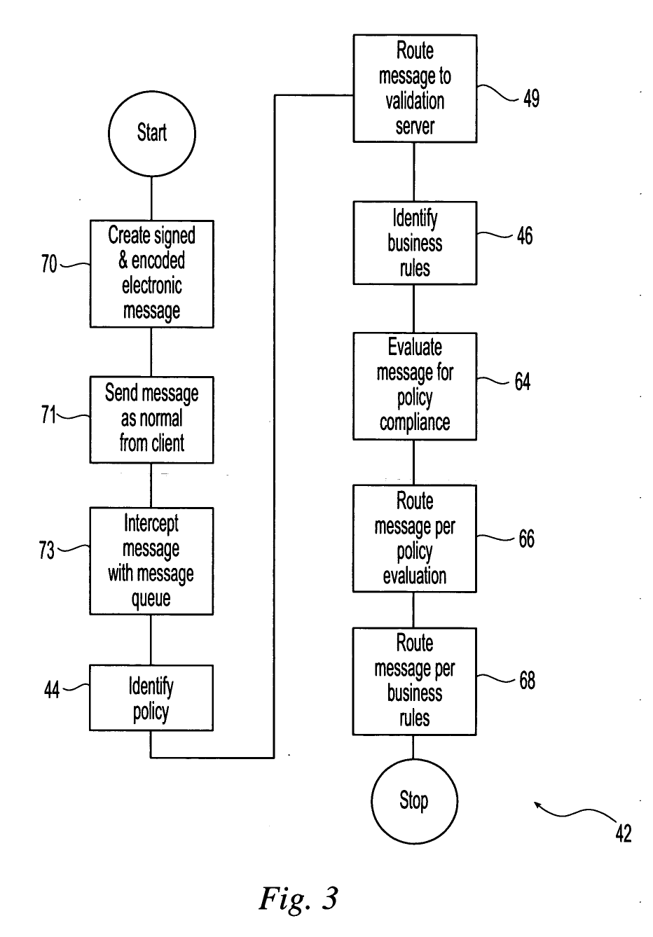

Referring to FIG. 3, the present invention is also directed to a method for evaluating the electronic messages 42 against one or more polices and business rules, including signature certificate validation. In one embodiment as illustrated, the method 42 includes identifying at least one policy 44 to be applied to an electronic message that has been sent from a first end entity to a second end entity. As used herein, the term policy refers to the logical expression of rules, either pre-defined rules, standardized rules or user-defined rules, governing the handling and routing of electronic messages to and from the end entities 12. These rules can govern the identity of users having permission to send or to receive electronic messages. In addition, the rules contain protocols for exchanging electronic messages between different domains and for the use of electronic signatures and encryption. Other rules apply to the actual content of the electronic messages and the control of users having access to that content. An example of a rule contained within the policies is that all electronic messages sent between two users have to be encrypted and signed. An example of another rule is that messages going to a particular domain only need to be signed if they discuss a particular topic, but all messages need to be encrypted. Therefore, as is shown in these examples, rules can vary in scope based on various electronic message-based factors including the identity of the senders, source domains and topics.

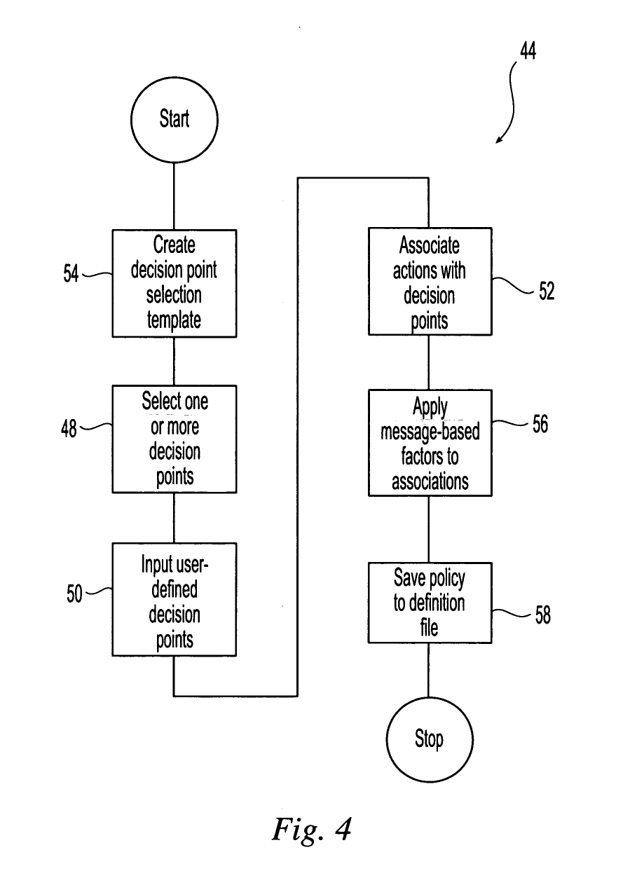

In one embodiment as illustrated in FIG. 4, in order to identify or to create a policy to be applied to the electronic message 44, one or more decision points are selected from a list of pre-defined decision points 48. Additional user-defined decision points can also be inputted 50 for inclusion in the identified policy. Each decision point defines a quality of the electronic message that can be evaluated. Suitable decision points, that can be stored in the pre-defined list of decision points for example, include verifying that the electronic message is signed, verifying that the electronic message is signed using a signature certificate issued by a trusted certificate authority, verifying that the first end entity owns the signature certificate, verifying that the signature certificate has not expired, verifying the signature certificate by verifying a certificate authority signature, verifying that a certificate revocation list to be used to verify the signature certificate is available and updated, verifying that the electronic message has not been modified after being sent by the first end entity, verifying a domain associated with the first end entity, verifying a domain associated with the second end entity, verifying that the electronic message is in the proper format and combinations thereof.

Associated with each decision point is one or more actions to be taken based upon the evaluation of the electronic message 52. Typical decision point actions include sending the electronic message to the second end entity, routing the electronic message to a third party, rejecting the electronic message, modifying the electronic message, notifying the first end entity regarding results of the policy evaluation, notifying the second end entity regarding the results of the policy evaluation, notifying the third party regarding the results of the policy evaluation, returning the electronic message to the first end entity and combinations thereof. The combination of a decision point and a decision point action constitutes a rule against which the electronic messages are evaluated. For example, the rule could be that if the electronic message was not signed using a valid signature certificate, the message is returned to the sender and the system administrator, i.e. a third party, is notified of the invalid signature certificate. In this example, the decision point is the evaluation of whether or not the message was signed using a valid certificate, and the decision point action is returning the message and notifying the administrator.

Therefore, a policy is constructed from one of more pairs of decision points and decision point actions. Once constructed, the policy can be saved to a policy definition file 58. These saved policies can then be easily accessed during message evaluation and can also be used in the future in the identification of a policy 44. In order to facilitate the selection of the decision points and the association of the decision points with appropriate actions, one or more decision point selection templates are created 54. These templates, however, are not necessary for the identification of policies.

In one embodiment, each identified policy can be applied to each electronic message regardless of any electronic message-based factors. These factors include, but are not limited to, the contents of the electronic message, the identity and domain of the sender and the identity and domain of the recipient. However, certain decision points may not apply to an electronic message containing certain message-based factors. For example, only messages going to a specific domain need to be signed. In addition, these message-based factors may dictate that different decision point actions apply depending on the outcome of the policy evaluation. Evaluating policies based upon message-based factors provides the benefit of a more efficient policy evaluation and a more efficient use of system resources, because resources and computation time are not used for policy evaluations that are not required.

Therefore, in another embodiment, electronic message-based factors are taken into account in the creation, selection, application or evaluation of each identified policy 56. As illustrated in FIG. 4, the message-based factors are taken into account during the association of actions with decision points. In another embodiment, the decision point templates can be used to assist in selecting decision points based upon electronic message content by constructing the decision point templates based upon electronic message-based factors.

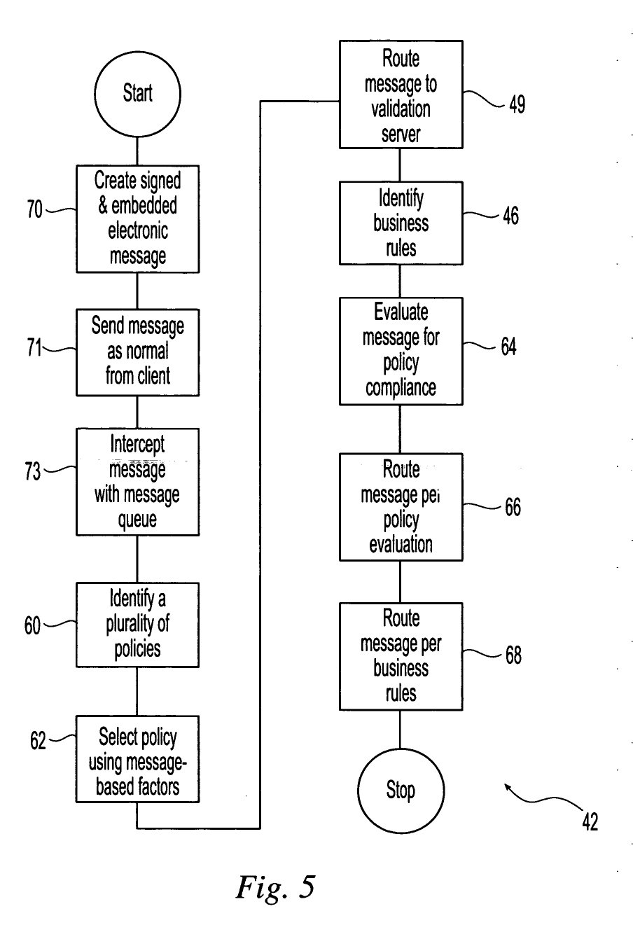

As is illustrated in FIG. 5, electronic message-based factors can be taken into account during the selection of a policy. In this embodiment, a plurality of policies capable of being applied to the electronic message are identified 60. The identification of each policy in the plurality of policies can be accomplished using the same procedures as described above and illustrated in FIG. 4 for the identification of a single policy. For example, for each policy, one or more decision points defined to evaluate a quality of the electronic message are selected, either from the list of pre-defined decision points or from user-inputted decision points, and one or more actions to be taken based upon the evaluation of the electronic message are associated with the decision points. Therefore, the identification of a plurality of policies is accomplished by iteratively identifying single policies based on varying factors until a sufficient number or variety of policies has been identified. In one embodiment, the plurality of polices contains a sufficient number and variety of policies to accommodate the variety of electronic messages to be evaluated. Once the plurality of policies is identified, one or more policies are selected for application to and evaluation of the electronic message or messages. Preferably as illustrated, the policies are selected for the plurality of identified policies using electronic message-based factors 62.

As is illustrated in FIGS. 3 and 5, in addition to defining suitable policies to be applied to the electronic messages, the method 42 of the present invention includes identifying at least one business rule 46 to be applied to the electronic messages. Business rules are typically not message content based or are not applied based upon electronic message-based factors. Instead, business rules reflect general business policies or software functions. Business rules handle routine business situations including user vacation notifications and lost or forgotten common access cards. In general, policies and business rules can be based on any attribute in the electronic message or on any PKI attribute. Alternatively, a determination can be made about whether a particular business rule applies to an electronic message using electronic message based factors. Again, using message-based factors in the application of business rules preserves system resources and expedites the evaluation process.

Once the policies and business rules have been identified, the electronic message is evaluated for compliance with the identified policy 64. Following policy evaluation, the electronic message is routed in accordance with the policy evaluation 66. The electronic message is also routed in accordance with any applicable business rules 68. The evaluation of whether or not the business rules apply is typically conducted during the identification of the business rule.

In one embodiment, in order to conduct the evaluation, each electronic message is routed to a certificate validation service contained on a validation server 49. In another embodiment, each electronic message is routed through a plurality of extensible policy verification servers. The plurality of servers can be arranged as a series of extensible policy verification servers, each having its own set of policies. Each message would pass sequentially through the servers. This type of arrangement illustrates a message passing through various domain levels en route to the recipient. Although a plurality of validation servers can be used, preferably, each electronic message is routed to a single, centralized validation server. The use of a centralized server provides for consistent, current, updatable and scalable application of policies.

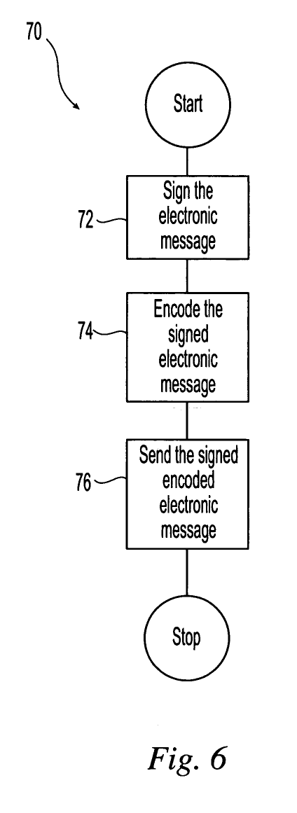

Using, for example, a PKI system, an electronic message is created, signed and encoded 70. As illustrated in FIG. 6, the electronic message is signed using a first end entity's private key 72 and is encoded using a second end entity's public key 74. The signed encoded message is then sent from the first end entity to the second end entity 76. As shown in FIGS. 3 and 5, in one embodiment the message can sent as normal 71 without checking policies or without checking business rules. Therefore, electronic messages that do not require processing can be forwarded without occupying system resources unnecessarily. In another embodiment, the electronic message is intercepted 73, for example by the message queue, and routed through the validation server 49. In one embodiment, one decision point in the applicable policy is the evaluation of the signature certificate associate with the electronic message. Therefore, evaluation of the electronic message includes checking a certificate revocation list for the status of the signature certificate associated with the message. In addition, the evaluation process can differentiate between revocation codes for cause and revocation codes for administrative purposes. The validity period and authenticity of the CRL can also be checked, and the results of these checks can be used to determine the actions to be taken on the message.

A certificate can be current, valid and in good standing or revoked, expired, and limited in scope of authority. If the private key of a public-private key pair is revealed or lost, the public key is invalidated through certificate revocation. In the case of a lost server key, a new certificate can be issued to replace any cached certificate. If a root certificate authority (CA) looses or compromises its private key, all certificates signed by the CA would be invalid because the lost key was the basis of the signing certificate.

Certificate validation services in accordance with the present invention can work with any secure multipurpose internet mail extension (S/MIME) compliant electronic message, independent of software application or hardware platform. In addition, the certificate validation service can differentiate between messages created with web-based clients, for example Outlook Web Access (OWA) or mobile E-mail devices and between hardware and software certificates.

The routing of the electronic message in accordance with the policy evaluation and the business rule applies, for example, the decision point actions associated with the decision points in the policy. Examples of routing procedures include sending the electronic message to the second end entity, routing the electronic message to a third party, rejecting the electronic message, modifying the electronic message, notifying the first end entity regarding results of the policy evaluation, notifying the second end entity regarding the results of the policy evaluation, notifying the third party regarding the results of the policy evaluation, returning the electronic message to the first end entity and combinations thereof.

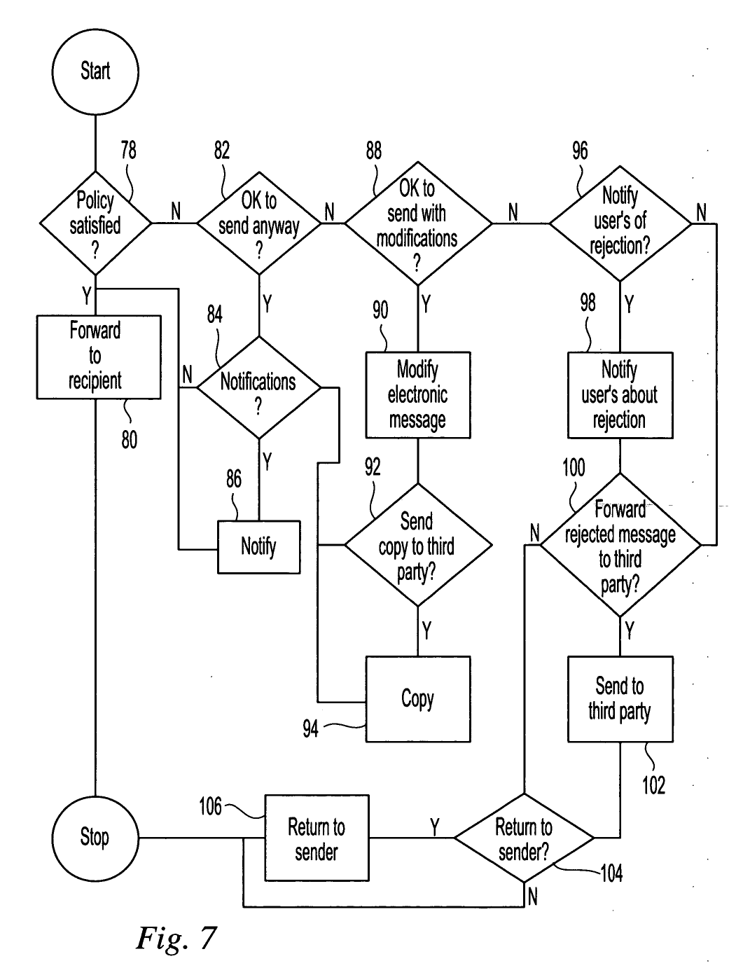

An illustration of an embodiment of policy evaluation and routing is shown in FIG. 7. This is an example only, and many other arrangements of evaluations and routing are possible in accordance with the present invention. Initially, a determination of whether the electronic message complies with the policy is made 78. If the policy is satisfied, the message is forwarded to the recipient 80. If the policy is not satisfied, a determination is made regarding whether or not the message can be forwarded to the recipient regardless of policy failure 82. This determination could be based, for example, on which decision point within the policy that the message failed to satisfy. This step could also take into account message-based factors if these factors where not already considered in the formation of the policy.

If the message can still be forwarded to the intended recipient, a check is made as to whether or not the sender, recipient or a third party needs to be notified about the policy failure 84. If not, the message is delivered to the recipient 80. If notification is required, the appropriate parties are notified 86, and the message is delivered to the intended recipient 80. For example, the recipient could be provided with a notification that the attached message is associated with an out-dated signature certificate. If the message cannot be sent for failure to comply with prescribed policy, a determination is made about whether the message could be sufficiently modified to be in policy compliance 88. If so, the message is modified 90, for example by removing sensitive material from the body of the message. A check is made about whether or not a third party, for example a system administrator, is to receive a copy of the modified message 92. If so, the copy is sent 94. If no copy is to be sent or following the sending the copy, an evaluation of notifications is made 84 and the message is processed as before.

If the message cannot be sent, even with modifications, then the message will be rejected and not delivered to the intended recipient. Preferably, the message will be intercepted and rejected before it even reaches the local server that provides for the electronic message functionality of the recipient. Once it has been determined that the message is to be rejected, a determination is made about whether or not the users, i.e. the sender or recipient are to be notified of the rejection 96. If so, then the users are notified with any appropriate explanation 98. Next a determination is made about whether or not to forward the failed message to a third party 100. For example, if the message contains sensitive or secret information that is not authorized to be transmitted in an electronic message, then the message could be forwarded to a security administrator that polices the transfer of sensitive material. If appropriate, the message is forwarded to the third party 102. Finally, a determination is made about whether or not to return the contents of the original message to the sender 104. If so, then the contents are returned to the sender 106 and may even include an explanation as to why the message was not delivered, for example, signature certificate failure.

Certificate validation methods in accordance with the present invention utilize a validation engine to facilitate verification of certificates and other user defined policies. The validation engine contains a wide variety of reliability and continuity capabilities. In general, the validation engine maintains current and up-to-date CRL's for all PKI's and automatically updates the CRL's as needed. The validation engine applies business rules independently to a CRL, providing the ability to customize the application of business rules. The validation engine provides the ability to time skew CRL data in case timely CRL's are not available from source directories. Although not required for proper operation, the validation engine can work with any Request for Comment (RFC) compliant on-line certificate status protocol (OCSP) responder. The policies or validation rules are easily created using a simple extensible mark-up language (XML), human readable format. The certificate validation service in accordance with the present invention can be implemented as a completely server based application without the need for any client-based software.

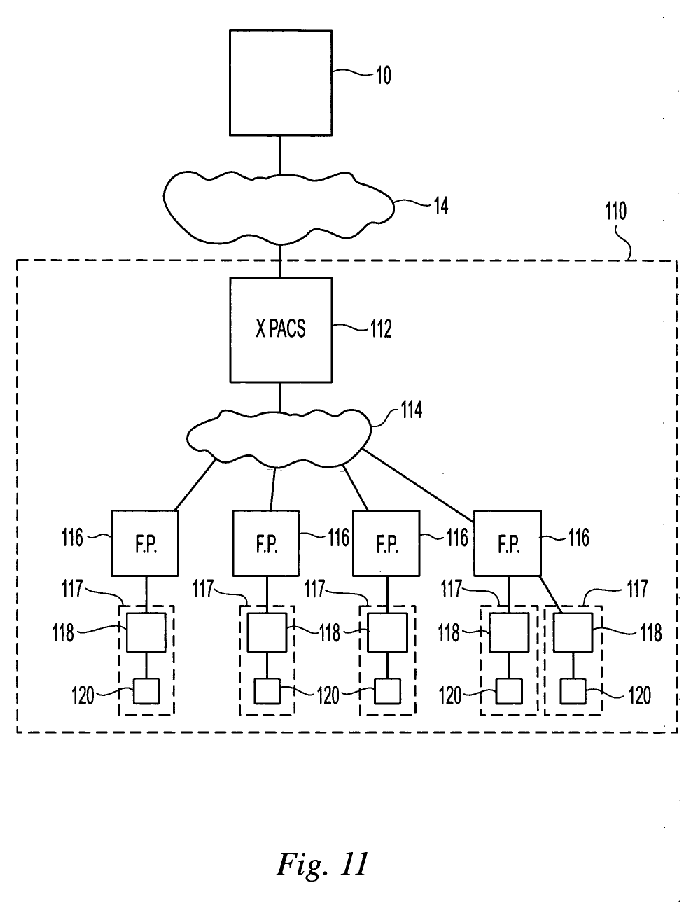

In one embodiment, the policy validation and application methods and system in accordance with the present invention are used in conjunction with physical access systems 110. Referring to FIG. 11, an exemplary embodiment of a physical access system 110 for use in conjunction with the policy enforcements systems 10 in accordance with the present invention is illustrated. The physical access system is any system that provides an automated system for limiting access to physical structures such as office buildings or secure sites. An example of a physical access system is a pass card system found in elevators and at entrance doors to office suites. Physical access systems for use in accordance with the present invention do not require any a priori knowledge of the credentials or tokens being presented at any given point of access within the system.

As illustrated, the physical access system includes at least one computer 112, a policy engine server or physical access policy engine, for example an extensible policy-based access control system (XPACS), that is in communication with one or more field panels 116. The computer may be connected directly to each one of the field panels or may be in communication with the field panels through one or more networks 114. Any suitable computer system, for example personal computer or programmable logic controllers, that are capable of communicating with the field panels and the policy system and of controlling the assembly and delivery of policies to the various field panels can be used. The field panels 116 are local panels that are in communication with and control one or more points of access 117 within the physical access system 110. The field panels control each point of access in accordance with pre-defined operating parameters and policies and business rules that are delivered by the computer 112. Suitable field panels are known and available in the art and have the ability to store policies, receive access requests and process the access requests in accordance with the polices. The physical access system is in communication with the policy enforcement system 10 through the network 14.

The points of access are associated with physical points and devices in the physical access system, i.e. doors, gates and elevators, and have the ability to receive input from an access device provided by an individual and of controlling operation of the physical devices. In one embodiment, each point of access includes a physical device controller 118 and an access card reader 117, both of which are in communication with the field panel 116. Any suitable physical device controller that can be control by the field panel can be used including magnetic door strikes, drop-pins, kill switches, electro-mechanical locks and combinations thereof. The access card reader includes any suitable input device such as keypads, biometric information readers and contact or contact-less reader that can be used to obtain or read information from access devices such as physical keys and identification cards or keys with information stored on magnetic media. In one embodiment, the access card reader is arranged to operate in conjunction with a token, for example a smart card such as a common access card. Output devices such as lights, light emitting diodes, liquid crystal displays and speakers can also be included in the point of access to provide feed back, indicate a current state of the system of prompt for more information.

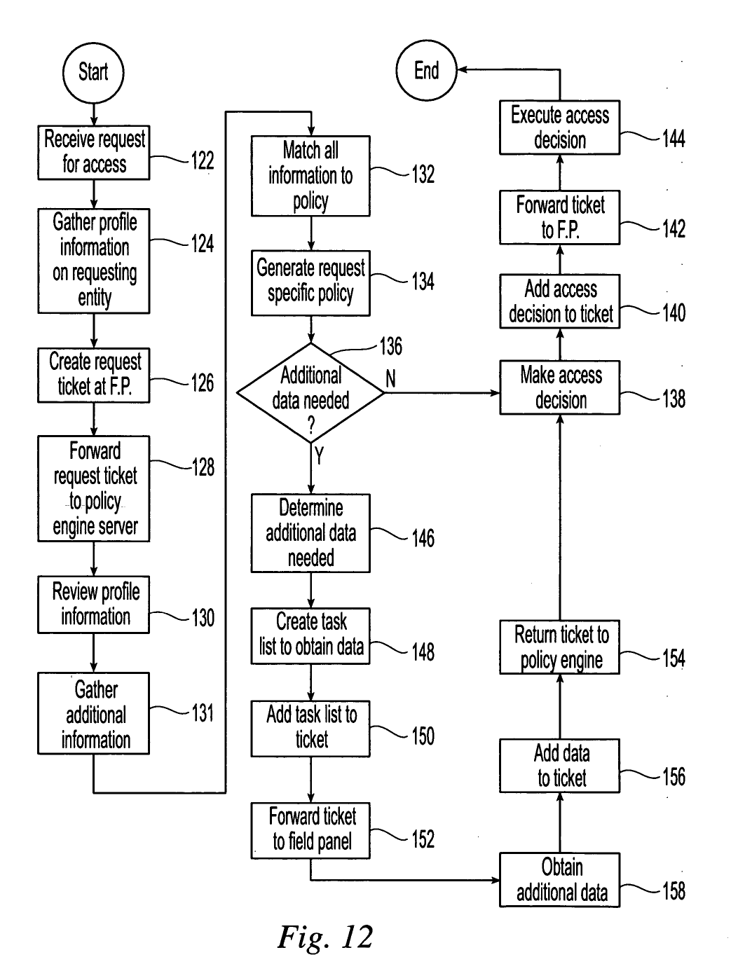

In one exemplary method of using the policy enforcement system to provide policy verification in physical access systems as illustrated in FIG. 12, an access request event occurs and a request for access is received at a point of access within the physical access system 122. In one embodiment, a card containing for example an encoded magnetic strip is brought into communication with a card reader at the point of access. In another embodiment, an entry code is entered on a keypad at the point of access. In addition, biometric information is provided. In one embodiment, a token is placed in communication with a reader, for example a smart card is placed in a card access device.

After the initial request for access is received, profile information on the requesting entity, i.e. the person or persons presenting the card or other request data, is obtained by the field panel through the point of access 124. The field panel uses a variety of devices at the point of access to obtain the desired profile information. These devices and methods include any suitable devices and methods for obtaining the desired information for creating or formulating a policy to be enforced including a single piece of information or multiple pieces of information. In one embodiment, the field panel sends commands to a card reader or card access device to read information off of the pass card or token. In another embodiment, the field panel sends data to a smart card requesting that the smart card actively sign data. The profile information obtained by the field panel may require requesting additional input from the entity requesting access. For example, a personal identification number, password or biometric data are entered on a keypad, touch screen, voice recognition for example using a telephone or suitable biometric data entry device. The field panel can also determine the type of pass card or token that is being used to request access, the type of card access or acceptance device used at the point of access, the location or identification of the point of access, the security zone being accessed and any other information that could be used in determining whether or not to permit access. Other suitable credential parameters to are provided or obtained include card holder unique identifiers, agency code, system code, security equipment integration working group code, federal access smart card number, global unique identifier and PKI certificate.

The field panel then creates a ticket containing all of the profile information that was obtained 126. Suitable methods for creating and delivering electronic tickets are known and available in the art. Suitable tickets are any file that contains the profile information in a form that can be communicated to a policy engine and read by that policy engine. Suitable languages for the ticket include extensible mark-up language. Any example of a ticket is listed below.

| | <?xml version=“1.0” standalone=“yes” ?> | |
|---|---|---|
| − | <ticket xmlns:xsi=http://www.w3.org/2001/XMLSchema-instance | |
| | | xsi:schemaLocation=“http://technologyindustries.com/XPACS |
| | | TicketXMLSchema.xsd” xmlns=“http://technologyindustries.com/XPACS”> |
| | − | <ifd> |

<location>Hallway 3</location>
<zone>2</zone>

| | </ifd> |
|---|---|
| − | <card> |

<type>CACv1</type>
<atr>odofoiaIOAF74AJA</atr>
<cuid>Vv78v7857A42356a</cuid>

| | </card> |
|---|---|
| − | <authentication> |

| | <pin>none</pin> |
|---|---|
| − | <pki> |

<challenge>BLYUFgyl68otGLYIgil7</challenge>
<response />

| | | </pki> |
|---|---|---|
| | </authentication> | |
| | <credential type=“idCertificate” | |
| | | issuer=“dmdc”>BLYUFgyl68otGLYIgil7</credential> |
| − | <policyList next=“PIN”> | |
| | | <policyNode status=“pending”>PIN</policyNode> |
| | | <policyNode status=“pending”>PKI</policyNode> |
| | | <policyNode status=“pending”>Cert Val</policyNode> |
| | | <policyNode status=“pending”>Done</policyNode> |
| | | <policyNode status=“pending”>Log</policyNode> |
| | </policyList> | |
| − | <taskList> | |
| | − | <task node=“PIN”> |

| | |
|---|---|
| − | <action index=“1” type=“Display”> |

| | |
|---|---|
| − | <input> |

| | |
|---|---|
| − | <p xmlns=“http://www.w3.org/1999/xhtml”> |

Enter
<b>PIN</b>
please.

</p>

| | </input> |
|---|---|
| − | <resultSwitch> |

<onResult result=“success”>2</onResult>
<default>return</default>

</resultSwitch>

| | </action> |
|---|---|
| − | <action index=“2” type=“CHV”> |
| | <update>pin</update> |
| − | <resultSwitch> |

<onResult result=“success”>nextTask</onResult>
<default>return</default>

| | | </resultSwitch> |
|---|---|---|
| | </action> | |
| | </task> | |
| − | <task node=“PKI”> | |
| | − | <action index=“1” type=“PKIEncrypt”> |

| | <update>pki</update> |
|---|---|
| − | <resultSwitch> |

<onResult result=“success”>nextTask</onResult>
<default>return</default>

| | | </resultSwitch> |
|---|---|---|
| | </action> | |
| | </task> | |
| − | <task node=“Cert Val”> | |
| | − | <action index=“1” type=“ReadCert”> |

| | <update>credential</update> |
|---|---|
| − | <resultSwitch> |

<onResult result=“success”>nextTask</onResult>
<default>return</default>

</resultSwitch>

</action>

</task>
</taskList>

</ticket>

Having created the profile ticket containing all of the gathered profile information, the profile ticket is forwarded to the policy engine server 128. In one embodiment, the policy engine server is a computer or other suitable processor such as a XPACS within the physical access system 126. The policy engine server receives the profile ticket and reviews the profile information contained within profile ticket 130. In addition, the policy engine server gathers any additional information or data that are necessary in the creation of a policy to be applied to the current request for access 131. This additional information includes, but is not limited to the current threat level or threat-con and the current time of day. This additional information can be generated by the policy engine server 112 itself or can be obtain from an outside third party source, for example, the policy verification system 10.

Using the profile information provided in the profile ticket and any additional information that was gathered, the policy engine server matches all of this information to at least one policy that is appropriate for application with the current request for entry 132. For example, a policy is chosen that is applicable to the type of request, the identity of the requesting entity, the location of the point of access and the current threat-con. In one embodiment, the applicable policy or policies are selected from a list of pre-defined policies. These policies can be generated or created at the policy engine server 112 or can be created in the policy verification system 10. The policy engine server may query one or more external systems for implementing a policy. Suitable external systems include, but are not limited to personnel systems, identity management systems, human resource systems, token management systems, PKI repositories and other access control systems.

Suitable systems and method for identifying and constructed polices are the same as identified above for policy enforcement in electronic messages and illustrated, for example, in FIG. 2. In one embodiment, policy engines, policy builders and databases within the policy enforcement system are used to create, maintain and update the policies to be used for physical access control. The system also provides for user-defined input into the physical access polices. Therefore, the policies governing physical access for any number of physical access systems and points of access that may be distributed across a large area can be controlled from a central location. Polices can be created to be universal among all of the physical access systems of can be customized for each physical access system or access point.

In one embodiment, the polices include physical access parameters to determine if a given person or individual using an access code or access device has permission to enter a given point of access based upon the factors including the current security or threat levels, the time of day and the authentication of the individual. Therefore, in order to create the policy, at least one physical access parameter to be applied to access requests at a given point of access is identified. In one embodiment, at least one physical access parameter is selected from a list of pre-defined physical access parameters for any current request for access at a given point of access. Suitable physical access parameters, for example, for the list of pre-defined physical access parameters include a list of permissible requests for access, time of day, threat condition, date, day of the week, holiday status, existence of sensitive or confidential meetings, credential verification, credential status, certificate status, identity status and combinations thereof. Alternatively, a plurality of policies capable of being applied to the point of access is identified, and at least one policy from the plurality of policies to be applied to the point of access is selected. The policy can be selected based upon factors that determine a current operational or security state including the time of day and a current security threat level.

Using the matched policy of policies, a request event specific policy is generated 134. Therefore, the policy is tailored to the current request of access at a specific point of access with the physical access system at a particular time of day but in compliance with overall policy parameters applied across the entire physical access system. The event specific policy can be varied from requesting entity to requesting entity. In addition, the event specific policy can be varied from location to location or point of access to point of access for the same requesting entity. For example, a first policy is applied for the requesting entity at the main entrance, and a second policy is applied for the entrance door to a laboratory. The profile information provided in the profile ticket and any additional information that was gathered are used to evaluate the request for compliance with the selected policy and to make decisions regarding access based upon the policy evaluation. However, the selected policy or policies may not have all of the desired data for making the policy evaluation. Therefore, in one embodiment, a decision is made about whether or not additional data are needed to make the policy evaluation 136.

If additional data are needed, then the desired data are identified 146. Next, a determination is made about how the desired information is going to be obtained. In one embodiment, this information can be obtained by the policy engine server directly from a third party source. Alternatively, the additional information is to be gathered from the field panel or from the requesting entity. Therefore, a task list is created to obtain the desired data 148. The task list includes instructions, commands, routines or prompts to be used to obtain the additional data. For example, the task list includes a request to obtain additional identifying information form the requesting entity or to confirm a password. The tasks are added to the ticket to create a task ticket 150. The task ticket is forwarded to the field panel 152. The field panel then obtains that additional information 158 for example by attempting to execute the tasks in the task list. The additional data are then added to the ticket to create an updated ticket 156 and the updated ticket is returned to the policy engine server 154.

In one embodiment, the policy engine server then determines is additional data are still needed 136, and the process is repeated until all of the desired data are obtained. In another embodiment, the policy server makes the policy evaluation and the access decision based upon all of the data obtained 138, regardless of whether or not all of the desired data have been obtained. Alternatively, the access decision is made following a determined that all of the desired data have been obtained and that no additional data are needed.

The access decision includes determining is the desired policy or polices have been satisfied by the provided data. In addition, actions to be taken based upon based upon the evaluation of a request for access are identified. Suitable actions to be taken include, but are not limited to, granting access, denying access, providing visual or audio output to the requesting party, notifying a third party, securing the point of access or combinations thereof. The access decision, i.e. the policy evaluation results, and any identified actions are then added to the ticket to create an access decision ticket. The access decision ticket is forwarded to the appropriate field panel or field panels 142, and the appropriate actions are executed at the appropriate access locations 144. The physical access system can be expanded or contracted to be as large and universal or small and contained as desired. In addition, the components or computers can be arranged or nested as desired. For example, the system can be constructed for a single point of access, and entire continent or the world. In addition, various components within the system can be used to perform other functions and not just those prescribed herein. For example, the filed panels can be eliminated and their functionality passed to the policy server or door controller.

In one embodiment, at least one business rule to be applied to the point of access within the physical access system is identified in addition to the identified polices. When the electronic ticket is created, both the identified policy and the identified business rule are included in the ticket, and any received request is evaluated for compliance with the identified policy and the identified business rule. In addition, access is granted at the point of access in accordance with the policy and business rule evaluation.

In one embodiment, policy validation in accordance with the present invention is used in combination with token technologies such as token technologies. In general, token technologies provide for portable authentication, integrity, confidentiality, tamper detection and non-repudiation. Token technology facilitates the authentication and identification of users and not just the computers or systems into which the smart cards are inserted. The ability to identify and to authenticate a particular user has grown in significance as the need for increased security has grown. Token technologies utilize tokens, preferably portable tokens, that are personalized to a particular individual, carried by that individual and used by that individual to access computers, computer networks and physical structures such as buildings. The selection and use of a given token involves balancing a variety of factors including ease-of-use, cost and strength or level of security provided. In general, tokens that increase the level of security also increase costs and decrease the ease-of-use. Therefore, for a given application, the token is chosen that strikes the desired balance among cost, security and ease-of-use. Preferred tokens that provide a good balance are smart cards, for example a common access cards (CAC).

Since lost, stolen or compromised tokens present a security risk to computers, networks and electronic databases containing confidential or personal information, systems and methods in accordance with exemplary embodiments of the present invention utilize a token firewall that prevents a given token from executing forbidden tasks or from being placed in an illegal state. Examples of states include, but are not limited to, a read state and a write state. The token firewall is used with any token that provides personalized security functions including, but not limited to, authentication, integrity verification, confidentiality protection, tamper detection, non-repudiation and combinations thereof. In one embodiment, the token includes public and private key pairs, certificate revocation lists and listings of revoked certificates that provide for the functionality of the token within PKI environments. Suitable tokens include memory tokens, processor or executable tokens and tokens that are both memory and processor tokens. Although the token firewall can be used in combination with any type of token, preferably, the token is a smart card, for example a CAC.

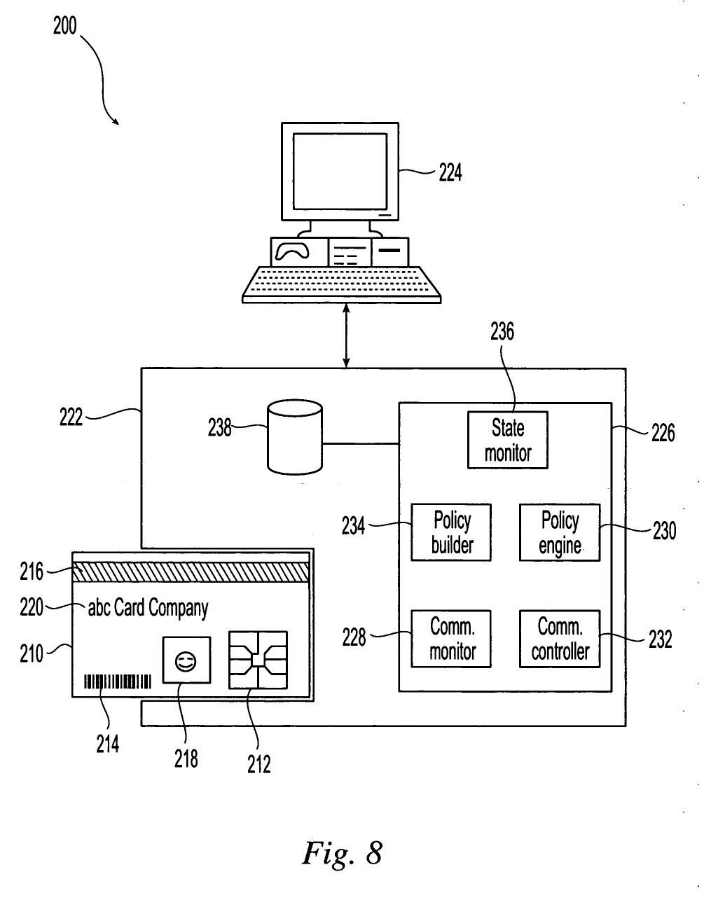

Referring to FIG. 8, an exemplary embodiment of a token firewall 200 in accordance with the present invention is illustrated. As illustrated, the token firewall includes a token 210 that has the ability to read and download information, upload information and execute routines. This ability is provided by an embedded integrated circuit chip 212 contained within the token 210. Suitable tokens 210 include, but are not limited to, PC Cards, hardware security modules, universal serial bus (USB) tokens, smart cards, for example a common access card (CAC), read-only magnetic strips, electronic purse cards, security cards, JavaCards and software tokens. Preferably, the token is a smart card or common access card.

Smart cards provide multi-application capability coupled with a virtually ubiquitous multi-functionality. In addition, smart cards provide this coupled capability in a form that is readily usable and easily transportable. All of the functionality of the smart card is provided in a device that is typically about the size of a credit card. The form and functionality of smart cards allow these cards to be used for physical and logical access applications and to be carried, for example, in a standard wallet, badge holder or shirt pocket.

In addition to the embedded integrated circuit chip 212, the token includes additional identifying and functional elements. These additional elements include, but are not limited to, a linear barcode 214, a magnetic strip 216, a two-dimensional barcode, a color digital photograph 218 and printed text 220.

The token in general and in particular the embedded integrated circuit chip can provide both memory and processor functions. These functions can be used alone or in combination on a given token. In one embodiment, the token is a memory token that provides for data to be written to and read from the integrated circuit chip. Suitable data include personal information, a personal identification number (PIN), demographic information, medical history, insurance information, physical security information, biometric information, card management information, public key infrastructure (PKI) information and combinations thereof. In one embodiment, a token contains three applets, a personal identification number (PIN) applet, a digital signature applet and a cardholder information applet. In one embodiment, the PIN is expanded from a basic PIN applet to an access control applet, which provides more information than simply a PIN. In another embodiment, the token is a processor token wherein the embedded integrated circuit chip is used to perform a variety of functions or operations on data that are written to or read from the token or stored in a computer or network in communication with the token. Preferably, the token is a combination memory and processor token. Therefore, the token provides the function of a small logic control unit and a memory device.

In one embodiment, the embedded integrated circuit chip 212 includes about 32,000 bytes to about 64,000 bytes of memory, which can be persistent modifiable memory, non-persistent modifiable memory, and persistent non-modifiable memory. Examples of suitable memory include read-only memory (ROM), random access memory (RAM), electronically erasable programmable read-only memory (EEPROM) and combinations thereof.

Tokens, however, do not contain any readily available input and output devices, i.e. a keyboard or screen, to facilitate user interface with the embedded integrated circuit chip. In addition, tokens lack an internal power source to power the chip. Therefore, the token firewall 200 includes a token reader 22 that is capable of communicating with the various elements contained in the token and in particular with the embedded integrated circuit chip. This input and output functionality as well as the supply of power is provided from the token reader to the token by either bringing the token reader into contact with the token, i.e. a contact device or reader, or bringing the token reader into sufficient proximity to the token, i.e. a contact-less device or reader. In one embodiment where the token is a smart card or CAC, the token reader is a card access device (CAD). Data stored on the smartcards is obtained by placing the smartcard in contact with, i.e. contact readers, or in proximity to, i.e. contact-less readers, devices that are capable of reading data from the embedded integrated circuit chip and writing data to the integrated circuit chip. After communication is established between the token and the token reader, data can be written to or read from the token and power is supplied to the token, for example power sufficient to power the execution of one or more routines on the embedded integrated circuit chip.

The token firewall 200 also includes a system 224 that is in communication with the token reader 222. Therefore, the token reader 222 provides the interface between the token 220 and the system 224. Suitable systems include, but are not limited to computers, computer networks and building access and security systems. Using the token in communication with the system with the token reader, users to whom the tokens are assigned are able to digitally sign E-mails and documents, to submit passwords for computer applications, networks and Web portals, to gain access to buildings such as dining halls, office buildings, libraries, military installations, schools and other public and private installations and to store digital photographs of the user and the user's biometric information. PKI certificates and revoked encryption certificates that users may still need are also stored in the memory that is resident on the smart cards.

The system 224 includes one or more terminal software applications with which the token communicates. Any suitable communication protocol can be used to communicate with the terminal software application. In one embodiment, the system 224 and in particular the terminal applications within the system communicate with the token by exchanging application protocol data units (APDU's), which are agreed upon or predetermined sets of commands and responses between the token and the terminal application. In general, the system or terminal application sends APDU commands to the token, and the token responds to these commands by sending APDU responses back to the system or terminal application. The format of the commands and responses are known and available in the art. In general any suitable format for commands and responses that can communicate with both the terminal application and the type of token can be used. Examples of suitable formats for commands and responses include, but are not limited to, command sets for contactless readers and for USB devices such as a USB key FOB. For APDU, each command includes a mandatory header including a class of instruction field, an instruction code field and two instruction parameter fields. Each command also includes an optional body that contains an indication of the number of bytes included in the data field of the command, the data field and an indication of the number of bytes expected in the response to the command. Each response includes an optional body including the response data field and a mandatory trailer including two status words that indicate the processing state of the token.

In order to provide communication between the token and token reader and the system or terminal application with which the token interacts, the token firewall also includes a token reader driver 226. The token reader driver is software that provides for the operation of the token reader and the communication protocols between the reader and the token and the reader and the system. In general, the token reader driver is specific to the token reader used, and suitable token reader drivers are known and available in the art. Although illustrated as a token reader driver any software capable of controlling the reader or token interface device can be used. In one embodiment, the token reader driver communicates directly with the system and the terminal applications running on the system. Preferably, however, the token reader driver and the terminal applications of the system are part of a hierarchical software stack (not shown). Suitable stacks are known and available in the art. One or more additional software levels are included in the stack between the driver level and the application level. These levels include, but are not limited to a cryptographic service provider and a PC/SC level, which is an interface for communicating with smart card type tokens from Win-32 based platforms for personal computers.

The functionalities of the token firewall are provided by enhancing, replacing or modifying or more levels of the software stack. In one embodiment, exemplary systems and methods in accordance with the present invention replace or modify software located at the lowest point in the stack in order to achieve the desired firewall functionality and to enforce policies between the terminal applications and the tokens. Examples of low level software include the driver levels for the token readers and the driver levels for interface ports such as Universal Serial Bus (USB) ports. In one embodiment, the token reader driver is replaced with a driver that provides the desired token firewall functionality. In addition, executable code capable or providing policy enforcement is stored and executed on the token itself. For example, at least one of the persistent non-modifiable memory, the non-persistent modifiable memory and the persistent modifiable memory can include an token level policy engine capable of enforcing an token level policy.

As illustrated in FIG. 8, the token reader driver 226 monitors the commands coming from the terminal applications to the tokens and the responses being generated by the tokens and passed back to the terminal applications for attempts to execute a forbidden or illegal action or to place the token into an illegal state. Changes or modifications in the token reader driver include a communication monitor 228 capable of monitoring the exchange of commands from the system to the token and of responses from the token to the system. In addition, the token reader driver includes a policy engine 230 capable of analyzing the monitored exchange of commands and responses for compliance with one or more pre-defined policies. In one embodiment, the policy engine analyzes any data field contained within the mandatory header or optional body of the command or the optional body or mandatory header of the response. A communication controller 232 that is capable of prohibiting delivery of commands and responses that are not in compliance with a pre-defined policy is also included in the token reader driver.

In one embodiment, the token reader driver is replaced with a token reader driver containing a policy builder 234 capable of building and updating the policy engine. In addition to simply monitoring the current or instantaneous state of the exchange between the token and the system, the token firewall provides for the monitoring and analysis of sequences of commands and responses. In one embodiment, the token reader driver includes a token state monitor 236 capable of monitoring a current operational state of the token and of logging a historical record of previous operational states of the token. This log can be stored, for example, in a database 238 contained within the token reader. Alternatively, the log is stored on the token. In one embodiment, the current operational state can be obtained from the status words contained within the mandatory trailer of each token response.

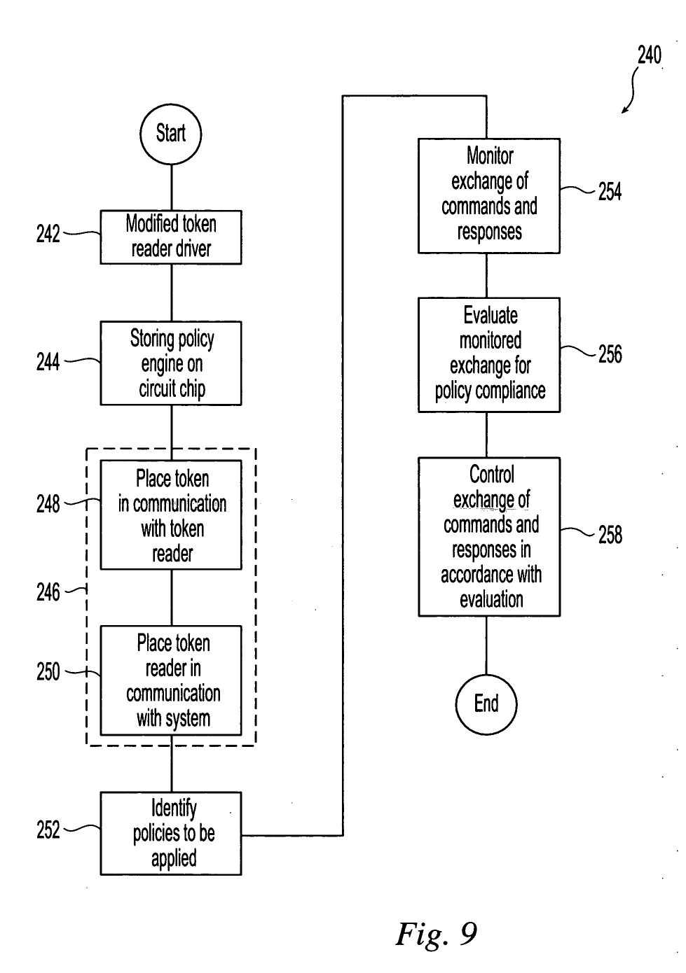

Referring to FIG. 9, an exemplary method for monitoring and controlling the state of an token 240 in accordance with the present invention is illustrated. Initially, at least one of the token, software stack, system and token reader driver are enhanced, modified or replaced to provide for the desired policy enforcement, token monitoring or token control. In one embodiment, software or drivers located at the lowest point in the stack are modified or replaced in order to achieve the desired firewall functionality and to enforce policies between the terminal applications and the tokens. Examples of low level software include the driver levels for the token readers and the driver levels for interface ports such as Universal Serial Bus (USB) ports. Preferably, the token reader driver is modified 242 to provide the desired token firewall functionality. Modification of the token reader driver includes modifying an existing token reader driver, replacing the existing token reader driven with a version containing the desired functionality, adding to an existing driver for example interfacing with an existing hook to add the desired functionality in a separate module and combinations thereof. This functionality includes, but is not limited to, monitoring the exchange of commands and responses between an token and a system, evaluating the commands and responses for compliance with a defined policy and controlling the exchange of commands and responses in accordance with the policy evaluation. In another embodiment, executable code capable of operating as a policy engine and providing policy enforcement is stored and executed on the token itself 244. For example, at least one of the persistent non-modifiable memory, the non-persistent modifiable memory and the persistent modifiable memory can include an token level policy engine capable of enforcing an token level policy. Modification of the reader driver can be used alone or in combination with policy enforcement mechanisms provided on the token. Similarly, the token can be used alone or in combination with the modified reader driver.

Having modified or replaced the desired components and drivers, communication is established between an token and a system 246. Suitable systems include any physical system or terminal application to which the authentication server provides authentication, integrity protection, confidentiality protection, tamper detection, non-repudiation and combinations thereof. Examples of these systems include computers, servers, networks, both secured and unsecured and physical access systems. In one embodiment, the token reader capable of establishing communication with the token is brought into communication with the token 248, and the token reader is placed in communication with the system 250. Therefore, communication is established between the token containing an embedded integrated circuit chip and the system. In one embodiment, a token reader driver, and in particular the modified token reader driver, is used to establish the communication between the token reader and the system. Any suitable token reader driver that is capable of communicating with the system can be used.

In one embodiment, the policies, and if desired business rules, to be applied to the exchanges between the token and the system are identified 252. In one embodiment, at least one policy is identified. Suitable policies and business rules include any of the policies and business rules discussed herein. In one embodiment, the identified policy prescribes limitations on the types of exchanges permitted between the token and the system, the data content of those exchanges and the operational state of the token. The operational state of the token refers to the current operation that is being performed by the token, for example reading data, writing data and executing a routine. The policies can be identified using any suitable methods including all of the methods described herein. In one embodiment, identification of the policy includes identifying impermissible exchanges between the token and the system. For example, when the token and system communicate by exchanging APDU commands and responses, the policy lists the impermissible commands and responses. In another embodiment, the policy includes a description of impermissible content that is not to be exchanged between the token and the system, including impermissible content in the commands and responses. In one embodiment, the policy includes an identification of permissible future operational states and impermissible future operational states of the token.

The application of policies is environmentally and contextually variable. For example, the token may initially be allowed to be placed in a state to download information to the system in order to provide the system with a PIN. Following download of the PIN and access to the system, downloads to the token are prohibited. Therefore, in one embodiment, the identified policy is modified or updated over time. In one embodiment, the policy is updated in response to a user initiated update. In another embodiment, the policy is updated in accordance with changing environmental conditions in the system or token. The policy can be updated at pre-defined, regular intervals. Alternatively, each policy is updated continuously over time.

Having established communication between the token and the system, the communications or data exchanged between the token and the system are monitored 254. In one embodiment, the APDU commands sent from the system to the token and the APDU responses sent from the token to the system are monitored. In one embodiment, the commands and responses are intercepted and stored temporarily in a buffer. The commands and responses are held in the buffer only long enough to perform any desired evaluation. The monitored exchanges, for example the monitored commands and responses, are evaluated against the identified policies 256 to determine if the commands and responses are in compliance with the identified policies. Based upon this evaluation, the exchange of commands and responses is controlled in accordance with the policy compliance evaluation 258. For example if the command or response is in compliance with the policy, then the command or response is delivered. Alternatively, if the command or response is not in compliance with the policy, delivery of that command or response is blocked. In one embodiment, monitoring, evaluating and controlling the exchanged communications is accomplished using the modified token reader driver, the embedded integrated circuit chip on the token or combinations thereof. Alternatively additional hardware or other portions of the software stack can be used to perform one or more of these functions.

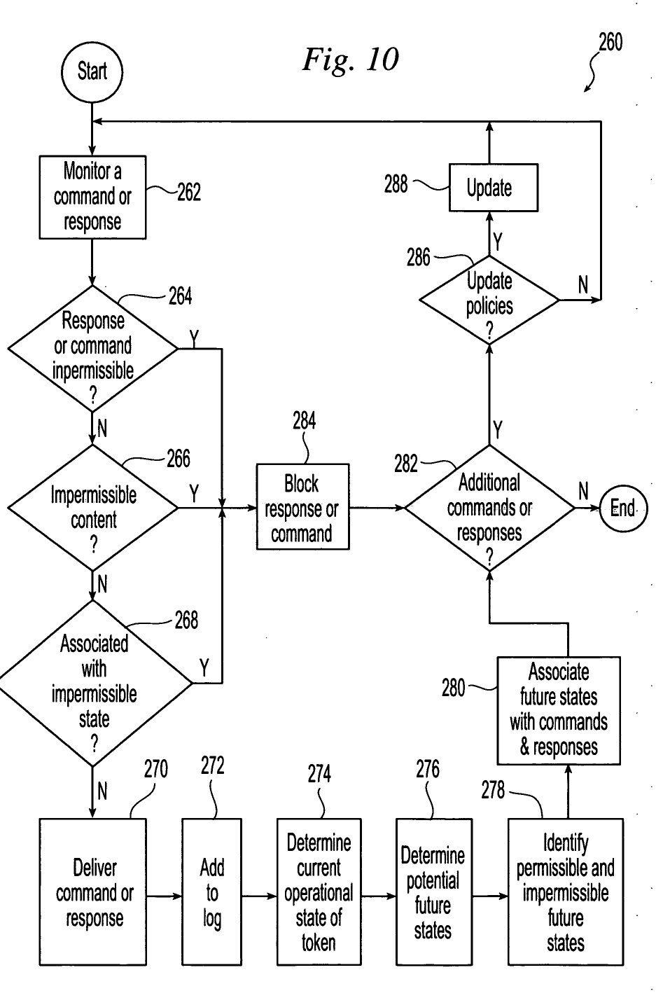

In one embodiment, the monitoring, evaluating and controlling of the exchanged commands and responses is handled on an iterative, sequential basis, one command or response at a time for the duration of the exchange of communications between the token and the system. Referring to FIG. 10, an exemplary embodiment of an iterative process for monitoring, evaluating and controlling exchanged data 260 is illustrated. Initially, a command or response exchanged between the token and system is monitored 262. In one embodiment, the command or response is intercepted and temporarily held in a buffer for evaluation and disposition. The buffer can be located, for example, in the token reader.

The monitored command and response is then evaluated against the identified policy. As illustrated, the policy includes lists of impermissible commands, impermissible data and commands that would place the token in an impermissible state. Initially, a check is made to determine if the command or response itself is impermissible 264, i.e. matches a command or response in the list of impermissible commands and responses expressed in the policy. If the response or command is contained in the list of impermissible commands, then that response or command is blocked from delivery 284. If the command or response is permissible, then the content of the command or response is checked to determine if all or a part of that content is impermissible 266, i.e. matches content contained in the list of impermissible content expressed in the policy. In one embodiment, the content includes a class of instruction, an instruction code, instruction parameters, command data field contents, response data field contents, processing state data and combinations thereof. If all or part of the content is impermissible then the command or response is blocked from delivery 284. In one embodiment, the type of command or response and the content of those commands and responses are determined by evaluating the class of instruction, the instruction code, instruction parameters, command data field contents, response data field contents, processing state data and combinations thereof. The blocking of commands and responses does not have to be accomplished in pairs. For example, a command could be permitted but the response to that command, which contains impermissible data is blocked. In one embodiment, a command requesting a certificate from a token is delivered. However, the data or content of the response does not appear to contain the requested certificate, and the response is blocked.

If the entire content of the command or response is permissible, then the command or response is evaluated to determine if the command or response would place the token into an impermissible or illegal state 268 as defined in the policy. Examples of impermissible states include, but are not limited to, placing the token in a read state for downloading data from the system, placing the token in a write state for uploading data to the system or placing the token in an executable state for executing one or more routines. In one embodiment, the current operational state of the token is determined and potential future operational states, both permissible and impermissible, are determined using the current operational state. In another embodiment, a historical log of exchanged commands and responses is maintained, and both the historical log and the current operational state are used to determined potential future operational states. Additional methods for determining potential future operational states include using a look-up table or a state machine. If the command or response is associated with an impermissible state of the token, then that command or response is blocked 284. If the command or response does not place the token in an impermissible state, then that command or response is delivered.

Since policies and the enforcement of policies is context or environment specific, exemplary methods in accordance with the present invention take this context into account when constructing policies and monitoring and evaluating exchanged commands and responses against these polices. In one embodiment, a historical log of exchanged commands and responses and operational states of the token is maintained and used to determine subsequent commands and responses that place the token in an impermissible or illegal state. In one embodiment as illustrated in FIG. 10, for example, following delivery of a command or response that is in compliance with the applicable policy, that command or response is added to the log 272. In one embodiment, the log is maintained in a memory or buffer location that is accessible to the policy engine that is enforcing the policy. In one embodiment, the log is stored in a memory location within the token reader. The number of commands and responses and past operational states stored in the log is selected to be sufficient to provide a prediction of potential future commands or responses. In addition to maintaining the log, the current operational state of the token is determined 274 if it is not already known. Based upon the historical log of commands and responses and the current operational state of the token, one or more potential future operational states of the token are determined 276. From this list of potential future operational states, both permissible and impermissible operational states are determined 278. Each potential future operational state is identified with at least one command or response that will take the token from its current operational state to the associated future operational state 280. Therefore, a list of commands and responses associated with impermissible future states is identified and used in the subsequent policy evaluation to determine if the next exchanged command or response is associated with an impermissible state 268. The log and associated lists are updated after each delivered command or response.

Preferably, policy checking and enforcement is conducted on all exchanged commands and responses between the token and the system. In one embodiment as illustrated in FIG. 10, after a response has been block or delivered, a check is made for additional commands or responses 282. If additional commands or responses are to be exchanged, then the system monitors the next command or response 262. If no additional commands or responses are to be exchanged, then the token firewall monitoring is halted. Therefore, the process is run iteratively on all exchanged commands and responses. In one embodiment, before the next command or response is monitored, a determination is made about whether or not the applied policy is to be updated or modified 286. If the policy is to be updated, then the desired updates are performed 288 before the next command or response is monitored.

The present invention is also directed to a computer readable medium containing a computer executable code that when read by a computer causes the computer to perform a method for policy enforcement and verification of electronic messages, for enforcement of physical access system parameters and for enforcement of a token firewall in accordance with the present invention and to the computer executable code itself. The computer executable code can be stored on any suitable storage medium or database, including databases in communication with and accessible across the network 14, and executed on any suitable hardware platform as are known and available in the art.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s). Therefore, it will be understood that the appended claims are intended to cover all such modifications and embodiments, which would come within the spirit and scope of the present invention.

What is claimed is:

1. A method for monitoring the state of a token, the method comprising:
establishing communication between a token and a system;
monitoring an exchange of commands from the system to the token and of responses from the token to the system;
identifying a policy to be applied to the exchange of commands;
evaluating the exchange of commands and responses for compliance with the identified policy; and
controlling the exchange of commands and responses in accordance with the policy compliance evaluation.

2. The method of claim 1, wherein the step of establishing communication comprises establishing communication between the system and a token that comprises an embedded integrated circuit chip.

3. The method of claim 2, wherein the step of establishing communication comprises establishing communication between the token and a token reader that is in communication with the system using a token reader driver.

4. The method of claim 3, further comprising modifying the token reader driver to monitor the exchange of commands and responses, to evaluate the commands and responses or to control the exchange of commands and responses in accordance with the policy evaluation.

5. The method of claim 1, wherein the step of monitoring commands and responses comprises monitoring application protocol data units exchanged between the system and the token.

6. The method of claim 1, wherein the step of identifying the policy comprises identifying a list of impermissible commands, responses and token states.

7. The method of claim 6, wherein the step of evaluating the exchange of commands and responses comprises comparing each exchanged command and response to the list of impermissible commands and responses and identifying matches between the exchanged commands and responses and the list of impermissible commands

8. The method of claim 7, wherein the step of controlling the exchange of commands and responses comprises blocking matching commands and responses from delivery to the token or to the system.

9. The method of claim 1, wherein the step of identifying the policy comprises identifying a list of impermissible content in the commands and responses.

10. The method of claim 9, wherein the step of evaluating the exchange of commands and responses comprises reading the contents of each exchanged command and response and identifying commands or responses containing impermissible content, and the step of controlling the exchange of commands and responses comprises blocking commands and responses containing impermissible content from delivery to the token or system.

11. The method of claim 1, wherein the step of monitoring the exchange of commands and responses comprises monitoring a current operational state of the token and determining potential future operational states using the current operational state.

12. The method of claim 11, wherein the step of monitoring the exchange of commands and responses comprises maintaining a historical log of exchanged commands and responses, and the step of determining potential future operational states further comprises using the historical log and the current operational state.

13. The method of claim 11, wherein the step of identifying the policy comprises identifying permissible future operational states and impermissible future operational states.

14. The method of claim 12, wherein the step of evaluating the exchange of commands and responses comprises identifying each potential future state as either permissible or impermissible based upon the identified policy, associating a necessary command or necessary response with each potential future state, the necessary command or necessary response capable of moving the token from the current state to the associated potential future state, identifying permissible subsequent commands and responses and impermissible subsequent commands and responses and identifying a next command or response as permissible or impermissible.

15. The method of claim 1, further comprising continuously updating the identified policy in accordance with a current operational state of the token.

16. The method of claim 2, further comprising using the embedded integrated circuit chip to monitor the exchange of commands and responses, to evaluate the commands and responses, to control the exchange of commands and responses in accordance with the policy evaluation or combinations thereof.

17. The method of claim 16, wherein the step of using the embedded integrated circuit chip further comprises storing a policy engine capable of enforcing the identified policy on the integrated circuit chip and executing the stored policy engine using the integrated circuit chip.

18. A token firewall comprising:
a token comprising an embedded integrated circuit chip;
a token reader capable of communicating with the embedded integrated circuit chip;
a token reader driver that provides communication between the token reader and a system with which the token interacts, the token reader driver comprising:
a communication monitor capable of monitoring an exchange of commands from the system to the token and of responses from the token to the system;
a policy engine capable of analyzing the exchange of commands and responses for compliance with a pre-defined policy; and
a communication controller capable of prohibiting delivery of commands and responses that are not in compliance with the pre-defined policy.

19. The token firewall of claim 18, wherein the token comprises a smart card.

20. The token firewall of claim 19, wherein the token reader comprises a card access device.

21. The token firewall of claim 18, wherein the token reader driver further comprises a policy builder capable of building and updating the policy engine.

22. The token firewall of claim 18, wherein the token reader driver further comprises a token state monitor capable of monitoring a current operational state of the token and of logging a historical record of previous operational states of the token.

23. The token firewall of claim 18, wherein the embedded integrated circuit chip comprises persistent non-modifiable memory, non-persistent modifiable memory, persistent modifiable memory or combinations thereof.

24. The token firewall of claim 23, wherein at least one of the persistent non-modifiable memory, the non-persistent modifiable memory and the persistent modifiable memory comprises a token level policy engine capable of enforcing a token level policy.

25. A method for policy verification in physical access systems, the method comprising:
receiving a request for access from a requesting entity at a point of access within a physical access system;
obtaining profile information for the requesting entity;
creating a profile ticket comprising the profile information;
forwarding the profile ticket to a policy engine server;
using the profile ticket to generate at least one request specific policy;
evaluating the request for access against the request specific policy to generate an access decision; and
granting access to the requesting entity at the point of access in accordance with the access decision.

26. The method of claim 25, wherein the step of gathering profile information comprises using interface devices located at the point of access to obtain the profile information.

27. The method of claim 25, wherein the step of creating the profile ticket comprises creating the profile ticket at a field panel within the physical access system.

28. The method of claim 25, further comprising reviewing the profile information contained in the profile ticket and gathering additional information.

29. The method of claim 28, wherein the additional information comprises threat condition, time of day, day of week, date, holiday status, existence of classified meetings or combinations thereof.

30. The method of claim 28, wherein the step of using the profile ticket to generate at least one request specific policy further comprises matching the profile information and the additional gathered information to a pre-defined policy.

31. The method of claim 30, wherein the step of matching the profile information further comprises matching the profile information and gathered information to at least one policy from a list of pre-defined policies.

32. The method of claim 25, further comprising determining if additional data are needed to evaluate the request for access against the identified policy.

33. The method of claim 32, further comprising:
identifying additional data needed to perform the evaluation;
creating a list of tasks sufficient to obtain the additional data;
adding the list of tasks to the profile ticket to create a task request ticket;
forwarding the task request ticket to at least one field panel within the physical access system;
obtaining the additional data using the list of tasks;
adding the obtained additional data to the task request ticket to create an updated profile ticket; and
forwarding the updated profile ticket to the policy engine server.

34. The method of claim 33, wherein the step of evaluating the request for access further comprises using the additional data to evaluate the request for access against the request specific policy to generate an access decision.

35. The method of calm 25, wherein the step of evaluating the request further comprises identifying one or more actions to be taken at the point of access.

36. The method of claim 35, wherein the action to be taken comprises granting access, denying access, providing feedback to the requesting entity, notifying a third party, securing the point of access or combinations thereof.

37. The method of claim 25, further comprising adding the access decision to the profile ticket to create an access decision ticket and forwarding the access decision ticket to one or more field panels within the physical access system.

38. The method of claim 25, wherein the step of granting access to the requesting entity at the point of access in accordance with the access decision further comprises using a field panel within the physical access system to grant access in accordance with the access decision.
